(19) United States
(12) Patent Application Publication
(10) Pub. No.: US 2021/0027315 A1
(43) Pub. Date: Jan. 28, 2021

(54) GENERATING DECISION TREES FROM DIRECTED ACYCLIC GRAPH (DAG) KNOWLEDGE BASES

(71) Applicant: International Business Machines Corporation, Armonk, NY (US)

(72) Inventors: Amit Nanavati, New Delhi (IN); Anil Maddipatla, Dilsukhnagar (IN); Birgit Monika Pfitzmann, Zurich (CH)

(21) Appl. No.: 16/522,527

(22) Filed: Jul. 25, 2019

(51) Int. Cl. G06Q 30/02; G06K 9/62

(52) U.S. Cl. CPC G06Q 30/0201; G06Q 30/0207; G06K 9/6282; G06K 9/6218

(57) ABSTRACT

A computer-implemented method of automatically identifying a product offering for a customer using a generated decision tree from a directed acyclic graph knowledge base is described. The method includes, by a processor, identifying a set of product offerings, where each product offering is described by a file. The method converts each file into a Directed Acyclic Graph (DAG) and clusters the DAGs. For each cluster, the processor creates a decision tree to distinguish between the product offerings.

### BACKGROUND

The present invention relates to identifying product offerings based on a request for production (RFPs), and more specifically, to a method of automatically generating product offering decision trees from a knowledge base (KB). A request for production is a request by a consumer for a particular product and generally includes certain criteria and/or features that the consumer would like to see in the product requested. Potential fillers submit responses to the RFP that indicate which of their products best meets the RFP. The requestor then sifts through the responses for selection of a particular product offering.

### SUMMARY

According to one embodiment of the present invention, a computer-implemented method of automatically identifying a product offering is described. The method includes, by a processor, identifying a set of product offerings, where each product offering is described by a file. The method further includes converting each file into a Directed Acyclic Graph (DAG). The DAGs are then grouped into clusters and for each cluster a decision is created to distinguish between the product offerings.

Also described is a computer program product for identifying a product offering for a user. The computer program product includes a computer readable storage medium having program instructions embodied therewith. The program instructions are executable by a processor to cause the processor to identify a set of Directed Acyclic Graphs (DAGs), wherein each DAG represents a product offering. The program instructions further cause the processor to group the set of DAGs into clusters based on attribute similarities between the DAGs. For at least one cluster, the computer program product creates a decision tree to select a particular DAG, wherein the decision tree selects first based on weight of attributes and second based on level in a hierarchy. The processer also identifies a closest product offering for the user based on the user traversing the decision tree.

Another embodiment describes a system for identifying a product offering for a user. The system includes a processor and a data storage device functionally connected to the processor. The system identifies a set of product offerings and converts each product offering into a Directed Acyclic Graph (DAG). The system then clusters multiple DAGs into clusters and for at least one cluster, creates a decision tree, wherein steps of the decision tree are determined based on a weight of attributes and then by a level in a hierarchy. The system also receives user input to traverse the decision tree and provides a product offering to the user based on an output of the decision tree.

### BRIEF DESCRIPTION OF THE SEVERAL VIEWS OF THE DRAWINGS

FIG. 1 shows a directed acyclic graph (DAG) for a product offering consistent with this specification

FIG. 2 shows a process for forming clusters of DAGs consistent with this specification.

FIG. 3 shows a decision tree for selecting a product offering in an example consistent with this specification.

FIG. 4 shows a computer system for implementing the described method consistent with this specification.

FIG. 5 shows a computer-implemented method of identifying a product offering for a customer consistent with this specification.

FIG. 6 shows a computer program product for identifying a product offering for a user consistent with this specification.

FIG. 7 shows a system for identifying a product offering for a user consistent with this specification.

### DETAILED DESCRIPTION

As described above, an RFP provides a system wherein a consumer can broadcast a need they have for a particular product, i.e., good or service. Potential vendors receive the RFP and submit a response that pitches their product to the consumer. While such environments effectively bring together a consumer and a provider, the process of selecting a particular provider and their respective product offering, may be labor intensive and inefficient. For example, the number of responses to the RFP may be very large and personnel for the consumer may sift through the RFP responses and determine the best product offering. In so doing, the consumer personnel use a number of criteria on which they base their decision for a potential product offering. From a potential provider's perspective, the process of selecting one of the various products to fill an RFP is similarly labor intensive and ineffective.

Accordingly, the present specification describes systems and methods that automatically generate a decision tree that distinguishes the different product offerings based on characteristics or attributes and is based on the specific requirements of the consumer in selecting a particular product offering. That is, a decision tree is a set of criteria to distinguish product offerings. Such decision trees allow a customer to identify a product offering that meets their requirements.

A product offering has a number of attributes. This number of attributes may be large and may make manual comparison of the product offerings time consuming. The described method and system convert the product offerings into directed Acyclic Graphs (DAGs). Each node of the DAG corresponds to an attribute of the product offering. The nodes have values indicating the state of the attribute. The attributes also have weights which indicate the relative importance of that attribute as compared to other attributes. In an example, a higher weight indicates greater importance and a lower weight indicates lesser importance. In another example, lower weights may be more important than higher weights.

As a specific example, consider a product offering of a personal computer system. Computer systems have a number of different attributes. Attributes can be binary, categorical, and/or continuous. For example, a computer system may have the attribute of hard drive size (in MB) which can be expressed as a continuous variable. The computer system may have a software revision attribute which is expressed in categorical notation (for example, the revision of the software). The computer system may have a binary attribute, such as whether the computer system includes a monitor. A computer system may have dozens of such attributes defining systems available from a supplier. When the supplier receives a request from a customer, the supplier seeks to match a computer system to the supplier's request. In some cases, the request may be in a formal document, such as a request for quote. In others, the request may be in an informal document such as a set of specifications described over the phone by the customer.

In this example, the various computer systems available from the supplier are described in a database of files. The files describe the specifications of the computer systems. However, the files may not be suitable for comparisons between different computer systems and/or matching the request from the customer. Accordingly, the files are converted into DAGs. DAGs have nodes with weights and are ordered. Accordingly, once the attributes are in the DAG, the process of clustering and comparing the product offerings (e.g. computer systems) is more readily solved.

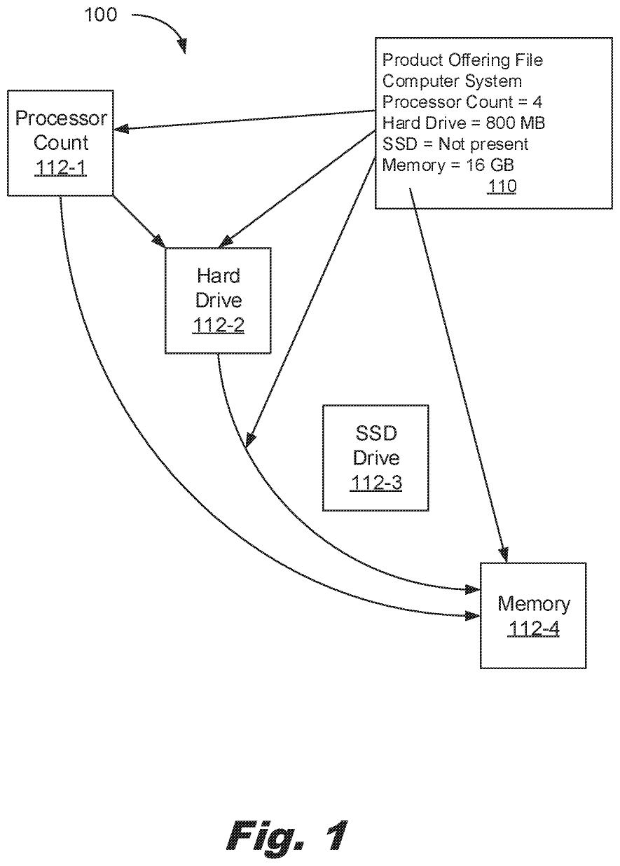

Turning now to the figures, FIG. 1 shows an example DAG f for a computer system product offering (110) in an example consistent with this specification. Each of the nodes (112) represents an attribute and has a value. Each of the attributes has a weight associated with it indicating its relative importance. The edges connect nodes (112) to other nodes (112) possessed by a product offering (110). While the product offering (110) represented in FIG. 1 is a computer system, such a DAG (100) could be created for any product or service. For example, the product offering (110) may be cloud services. The described approach is useful when the product offering (110) is defined by a large number of attributes.

Converting files to DAGs: Converting files into DAGs (100) allows for comparison of the product offerings (110). Converting files into DAGs (100) also facilitates clustering the product offerings (110). For example, the product offerings (110) may be products offered by different vendors to meet an RFP or may simply be different product offerings (110) that were collected for analysis independent of an RFP to identify products that best meet a particular consumer's requirements for that product. In other words, DAGs (100) may be used by consumers to evaluate responses to an RFP or may be used by vendors responding to an RFP, as well as in other circumstances.

The set of product offerings (110) may be part of a knowledge base. That is, a consumer may have a database that delineates a number of product offerings (110) and includes the files that describe the attributes of each product offering (110). In one particular example, the product offerings (110) may be defined by a JSON (JavaScript Object Notation) file in the knowledge base. In other examples, the product offerings (110) may be defined in a non-SQL database. In an example, the product offerings (110) are Global Trade Services (GTS) solution modules (GSMs). That is the product may describe cloud computing services. However, the product offerings (110) may be other services. The product offerings (110) may relate to physical products as well, such as desktop computers systems.

Each value in the file is assigned to a node (112). If the file lacks a value for a node (112), the null value may be assigned. If the file has entries which do not have existing nodes (112), the DAG (100) is expanded adding new nodes (112). The new nodes (112) may be set to null for previous DAGs (100) which lack that attribute (since that attribute was not in the default DAG).

Once in a directed acyclic graph (100) form, the files can be compared and grouped into clusters based on differences/similarities. In other words, the differences/similarities may be used in the clustering process to form clusters of related product offerings (110). In a specific example, the product offerings (110) are cloud computing services. In this example, the product offerings (110) may each have attributes that may describe product features such as server location, specifications, and other features. These attributes may be described in a JSON file and can be extracted when converting into the directed acyclic graph (100).

Weights: Each attribute may be assigned a weight. A weight is an indication of the relative importance of that attribute in client selection of a product offering (110). In an example, weights are provided with different values so as to provide a means of selection between the attributes. Weights may be assigned by a user such as a user who the initiated of the RFP. In some examples, the user may be an expert in the offerings. In another example, the user may be a customer.

In other examples, weights may be assigned by a computing system and then reviewed by a user. The user may have the option to adjust the weightings, for example by dragging and dropping the attributes into a different order. In another example, the weights may be assigned by a computing system without user input.

Weights are used during the clustering process to help assure that the clusters are grouped based on attributes of interest to the client. Weights are also used when generating the decision trees to determine which attributes should be prioritized for decision making. Attributes with higher weights represent those attributes more important to the client, and are thus prioritized over attributes with lower weights.

In an example, the weights are assigned using a Term Frequency-Inverse Document Frequency (TF-IDF) algorithm. The term frequency may be binary, raw count, term frequency, log normalization, double normalization 0.5, and/or double normalization of K. The inverse document frequency may be unary, inverse document frequency, inverse document frequency smooth, inverse document frequency max, and/or probabilistic inverse document frequency. Similar variants of TF-IDF approaches may be substituted, for example, a variety of relative weightings between the TF and IDF terms may be used.

In one example, weights may be assigned based on a regressed cost of the attribute. The regressed attribute cost is an estimate of the contribution of the attribute to the total cost of the product offerings (110). In some examples, the regressed attribute cost may be based on a set of accepted proposals. For example, a set of accepted proposals with total costs may be collected. An attribute cost for each attribute may then be determined from the total costs using multivariate analysis. The attribute costs may then be used to order the weightings of the attributes. For example, attributes with higher attribute costs may receive a higher weight and attributes with lower attribute costs may receive a lower weight. As a specific example of a regressed attribute cost, the regressed attribute cost of an 800 MB hard drive may be $60 of the total cost of a personal computer system. The attribute costs of all the attributes may be determined from a set of proposals or bids. As described above, this approach uses the attribute costs to generate the weights. Using this approach, the amount people are willing to pay for the attribute provides a basis for valuation of that attribute (i.e., the attribute cost). Accordingly, this approach provides an automated method of generating weights without depending on user input. While particular reference is made to attribute costs determined based on accepted proposals, in some examples, all generated proposals may be used to determine attribute costs.

In another example, the weight for each attribute is obtained from a file. For example, the weight may be provided by a user such as a customer and/or a subject matter expert. The user may adjust predetermined and/or automatically generated weights. In some examples, the attributes are provided as an ordered list for a user to review and reorder. The reordering actions of a user may provide the weights assigned to the attribute. In some examples, weight generation may be automatic based on the order generated by the user. In an example, the reordering may be a drag and drop where the weight is assigned the median value between the new previous and new next attribute weights. That is, if an attribute is dropped immediately between attribute 1 having a weight of 0.5 and attribute 2 having a weight of 0.4, the newly moved attribute would be assigned a weight of 0.45.

In some cases, it may be useful to add least significant figures to weights for two attributes to distinguish between two weights that share a value. For example, if two attributes are both weighted 0.22, then they might be randomly weighted 0.221 and 0.219.

Separation: Separation is a measure of difference between two DAGs (100). A higher separation indicates greater difference between the two DAGs (100). A lower separation indicates greater similarity between two DAGs (100). Once files are converted to DAGs (100) and have weights assigned to attributes, the separation between DAGs (100) may be calculated using a number of formulae. This separation is used to cluster the DAGs (100). In one example, the formula is Σw(a)*(v1−v2), where w(a) represents the weight of attribute a, v1 is the value of attribute a in the first DAG (100) and v2 is the value of attribute a in the second DAG (100). In another example, the formula is Σw(a)*abs(v1−v2). In another example, the formula is Σw(a)*(v1−v2)\hat{ }2.

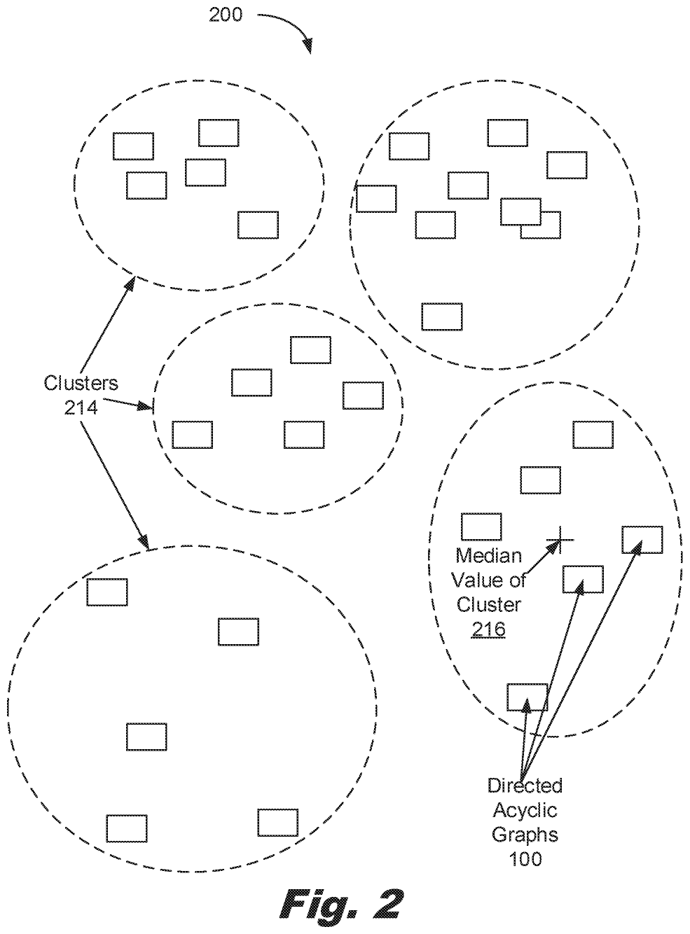

Turning to FIG. 2, once the product offerings (110) have been converted to DAGs (100), the DAGs (100) are grouped into clusters (114) of related DAGs (100). Again, each DAG (100) describes a product offering (110) and each cluster (214) is a group of related or similar product offerings (110). For instance, with the computer system example, the clusters (214) may group different computer systems based on price or types of computer systems (workstations, gaming computers, desktops, etc.).

In general, attributes of the DAGs (100) can be compared and DAGs (100) with a threshold similarity across attributes may be grouped together. For example, if two DAGs (100) have a certain percentage of attributes that are the same, or within a predetermined separation of one another, then these DAGs (100) may be combined into a single cluster (214). As one specific example, a cluster (214) may include all product offerings (110) with the attribute of “available in France” and the attribute of “available in Germany.” Grouping the DAGs (100) produces smaller sets of related DAGs (100) (clusters) which can then be used to construct decision trees. That is, a cluster (214) contains a set of similar product offerings (110), where the similarity of the product offerings (110) is a function of the differences between the product offering (110) attributes.

In some examples, the DAGs (100) may be clustered by assessing the weighted separations between different DAGs (100). The separations between DAGs (100) is based on differences in the attributes of the product offerings (110) associated with the DAGs (100). In an example, all DAGs (100) with a separation below a given threshold are grouped into a single cluster (214). In some examples, the threshold may be dynamically adjusted to adjust the size of the clusters (214), number of clusters (214), levels of the decision trees produced from the clusters (214), or other factors. For example, a larger separation threshold may produce larger clusters (214), while a smaller separation threshold may produce smaller clusters (214). Dynamically adjusting the threshold may be useful to control the size of the clusters (214) as the number of offerings (110) increases.

In some examples, clustering may be based on random seeding of a set of DAGs (100) and then adding DAGs (100) to a cluster (214) based on their similarity to the seed DAGs. For example, multiple product offerings (110) are randomly selected to act as seeds for the clusters (214). A non-seed product offering (110) is then selected. The distance between the non-seed product offering (110) and each of the seed product offerings (110) is measured and the non-seed product offering (110) is clustered with the closest seed. This process is repeated until all the product offerings (110) are assigned to a cluster (214). The clusters (214) may then be size checked. That is, small clusters (214) may be merged and large clusters (214) may have multiple seeds randomly selected and the process repeated.

In some examples, the clusters (214) represent the shortest distance to a median value of a cluster (214) for each product offering (110) in the cluster (214). The median value of a cluster (214) is the average of all the DAGs (100) in the cluster, applied attribute by attribute. For example, if the attribute is hard drive space, and the cluster has DAGs having values of 600, 800, 800, 800, 1000, and 2000 MB, then the median value of this attribute for the cluster (214) is 1000 MB. In this example, the system may parse through each product offering (110) and if the system finds a median value for a cluster (214) that has a shorter distance relative to that product offering (110), transfer the product offering (110) to the closer cluster (214). In some examples, the system excludes the impact of the considered product offering (110) when determining the closest cluster (214). In other examples, the system includes the impact of the considered product offering (110) for both clusters (214) when assessing the closest cluster (214).

The clustering module may use other approaches to cluster the DAGs (100) as well, such as K-means clustering or Gaussian expectation-maximization model. As described above, the clusters (214) may be of a predetermined size. Also as described above, the clustering may be iterative and based on decision tree size. In some examples, clustering may be hard clustering where each DAG (100) is assigned to one and only one cluster (214). In other examples, clustering may be overlapping such that a DAG (100) may be assigned to multiple clusters (214).

In some examples, each cluster (214) is assigned an initial size. For example, the clusters (214) may be initially sized to hold 10% of the total number of product offerings (110). The clusters (214) and/or cluster sizes may then be refined by as product offerings (110) are added or moved to neighboring clusters (214). In some examples, the system may dynamically modify the clustering to control a mean size of the clusters (214). In an example, the mean cluster size is selected based on a number of levels in a resulting decision tree. For example, cluster size may be adjusted such that there are no more than four levels in a decision tree. As not all decision trees will be perfectly symmetrical, a limit of four levels may impose a maximum cluster size smaller than 16, for example 12, 10, or some other value.

In some examples, a composite product offering is formed based on the clustered DAGs (100). In this example, the composite product offering is formed by combining the attributes for each DAG (100) in the cluster (214). In other words, the composite product offering represents a summation of each of the product offerings (110) associated with the cluster (214). In the composite product offering, attributes not possessed by a particular product offering (110) in the cluster (214) may be assigned a null value. In some examples, attributes not possessed by any particular product offering (110) in a cluster (214) are assigned a default value in the composite product offering. For example, the default value may be a lowest cost value. The composite product offering contains all the attributes, even if no product offering (110) exists with values for all the attributes. As noted above, null values may be used to fill in when no information is available on an attribute for a given product offering (110).

In some examples, a cluster (214) is identified which has a smallest separation to a product included in a request for production. That is, in some examples, a document may include a product description. For example, the document may be a request for production or another type of request, for example, a request for quote (RFQ). The extraction process identifies attributes in the document and converts the attributes to a DAG (100). The extraction process may include reviewing each attribute for its presence in the document and then matching the attribute to a known value. In some examples, if there is no known value that matches the attribute, the attribute is flagged for review by a user. Once all the attributes have been checked, any attributes where a value was not identified may be given a null value, indicating that it is not prioritized when determining separation to product offerings (110).

Accordingly, the attributes of the product identified in the RFP may be automatically extracted and a separation determined between the attributes of the RFP product and each of the various clusters (214). In another example, a median value (216) for a cluster (214) is used for each cluster (214) and the closest cluster (214) is identified based on a separation between the median value (214) of the clusters (214) and the product in the RFP. In another example, each individual product offering (110) is compared against the product in the RFP and the closest product offering (110) is identified. In this example, the closest cluster (214) is the cluster (214) that includes the product offering (110) with the smallest difference. In some examples, this closets product offering may be considered the final offering. However, because the RFP may lack terms, a decision tree for the closest cluster (214) may be parsed to find the customer's actual preferred product offering (110).

In some examples, the system may receive a new product offering (110) and, in response, update the clusters (214) and decision trees. In this example, the system may recalculate just the decision tree associated with a cluster (214) to which the new product offering (110) pertains. This allows the other decision trees to be kept the same, reducing the processing resources required. In other examples, each new product offering (110) causes the system to cluster the product offerings (110) again and create decision trees for any modified clusters (214). This may prevent any particular cluster (214) from becoming overly large as compared with the other clusters (214). In some examples, the system checks the size of the cluster (214) receiving the new product offering (110) before deciding between localized or general reprocessing of the clusters (214) and decision trees. In an example, the system may perform just the reprocessing of the decision tree associated with the cluster (214) receiving the new product offering (110) unless, for example, that cluster (214) is greater than twice the size of a smallest cluster (214).

In an example, the decision tree for the cluster (214) has fewer levels than a decision tree for all the set of product offerings (110). In some cases, the decision tree for the cluster (214) may have a same number of levels as the set of all product offerings. This, in turn, may reduce the number of levels of a decision tree which a customer needs to traverse in order to reach their desired product offering (110).

In an example, the decision tree includes at least one tiebreaker based on weight and at least one tiebreaker based on level in the hierarchy. In another example, all tiebreakers are based on weight. In some examples, all tiebreakers are based on level in the hierarchy. The tiebreaker is the attribute used to decided in a level of the decision tree (300).

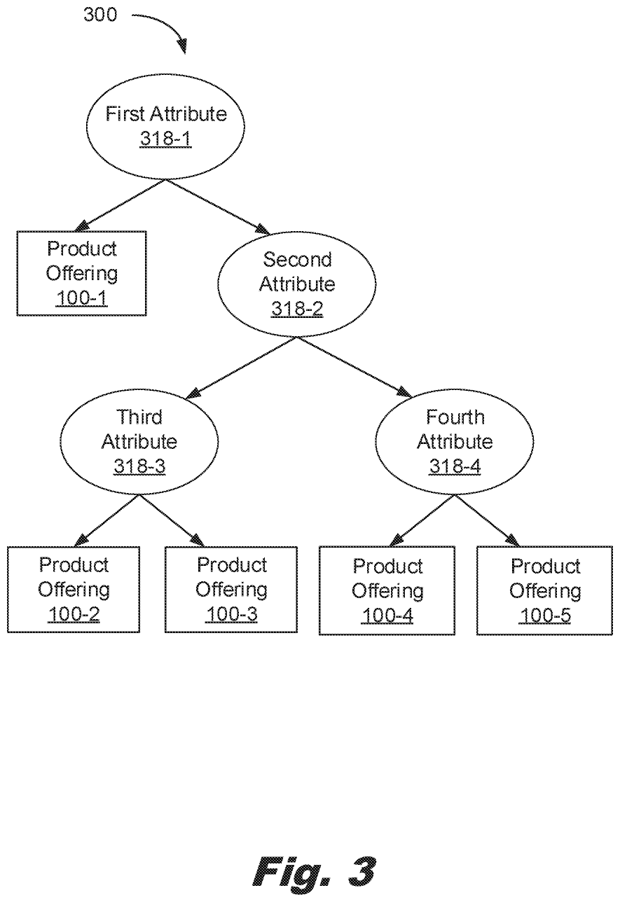

FIG. 3 shows a decision tree (300) for a cluster (214) according to an example consistent with this specification. The decision tree (300) includes a set of levels. Each branch of the decision tree (300) is defined by an attribute (318). The attribute (318) is compared with a value or values provided by a user and/or Extracted from the RFP. The results used to progress to the next level of the decision tree (300). Upon reaching a leaf node, a product offering (110) associated with the leaf node is identified.

The decision tree (300) includes decision nodes based on attributes (318). For example, for computer product offerings (110), the node could distinguish based on processor speed. The decision tree (300) includes leaf nodes representing product offerings (110). That is, each leaf node correlates with a product offering (110). The decision tree (300) is shown as a binary tree but may be a non-binary tree, especially if the attribute (318) being used at a level is categorical or continuous. For example, a level based on hard drive capacity in MB could be considered continuous with groups of less than 200 MB, 200 to 800 MB, and more than 800 MB. Alternately, a non-binary decision tree (300) may be transformed into a binary decision tree (300) by grouping the categorical and/or continuous attributes (318) into two groups. For example, a mean server response time (a continuous variable) can be converted into a binary attribute (318) by setting it to a mean server response time of less than 200 milliseconds.

In an example, a decision tree (300) algorithm such as Iterative Dichotomiser 3 (ID3), the C4.5 algorithm, and/or C5.0 or See5 is used to form the decision trees (300). Selecting which attribute (318) is used to decide a level of the decision tree may be decided by weight of the attribute (318) (highest weights first) and/or by level in the hierarchy of the decision tree (300). In an example, weights may be used as a first tiebreaker and level in the hierarchy as the second tiebreaker. In some examples, the weights are selected to avoid ties. For example, a list of attributes (318) may be presented to a user in order of weight and the user may adjust the order (and the corresponding weights).

The system may include instructions to receive user input to traverse the decision tree (300). For example, the decision tree (300) can be displayed stepwise to a user, for example as a series of questions. The user can traverse the decision tree (300) by selecting answers to the questions. That is, the user is provided options based on weighting or other factors to traverse the decision tree (300). In some examples, the decision tree (300) includes more than two options per node. For example, a node could branch to a variety of different values rather than just a pair of values. This may be particularly useful for continuous variables and/or variables with a large number of options (e.g., countries where a server may be located). For example, with a computer system, the user could select hard drive size of fewer than 200 MB, between 200 and 800 MB, and more than 800 MB in order to traverse the tree (300) to a preferred product offering (110).

Once the decision tree (300) is traversed, the system may include instructions to provide a product offering (110) to the user based on an output of the decision tree (300). In addition to recommending a product offering (110), the system may identify all the attributes (318) of the recommended product offering (110). This may include identifying all attributes of the recommended product offering (110) that have a non-null value. In some examples, the recommendation may be provided as a bid, including a cost. In some examples, the recommendation may be presented in a format defined by a request for quote.

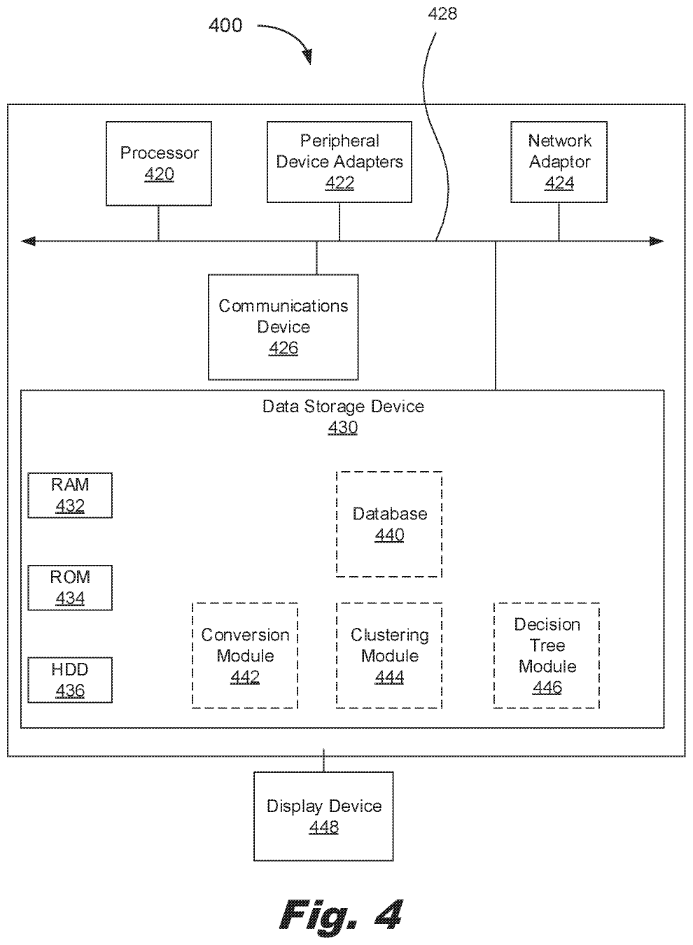

FIG. 4 shows a computer system (400) of automatically identifying a product offering (110) for a customer. The system (400) may be implemented in an electronic device. Examples of electronic devices include servers, desktop computers, and laptop computers among other electronic devices.

The system (400) may be utilized in any data processing scenario including, stand-alone hardware, mobile applications, through a computing network, or combinations thereof. The system (400) may be used in a computing network.

To achieve its desired functionality, the system (400) includes various hardware components. Among these hardware components may be a number of processors (420), a number of data storage devices (430), a number of peripheral device adapters (422), and a number of network adapters (424). These hardware components may be interconnected through the use of a number of busses (428) and/or network connections. In an example, the processor (420), data storage device (430), peripheral device adapters (422), and a network adapter (424) may be communicatively coupled via a bus (428). The system (400) may further include a number of communication devices (426) which are connected with other processors (420).

The processor (420) may include the hardware architecture to retrieve executable code from the data storage device (430) and execute the executable code. The executable code may, when processed by the processor (420) cause the processor to convert files describing product offerings (110) into DAGs (100), cluster the DAGs (100) corresponding to the product offerings (110), and generate a decision tree (300) for a cluster of DAGs (100). In the course of executing code, the processor (420) may receive input from and provide output to a number of the remaining hardware units.

The data storage device (430) may store data such as executable program code that is executed by the processor (420) and/or other processing devices. The data storage device (430) may specifically store computer code representing a number of applications that the processor (240) executes to implement the functionality described herein.

The data storage device (430) may include various types of memory modules, including volatile and nonvolatile memory. For example, the data storage device (430) of the present example includes Random Access Memory (RAM) (432), Read Only Memory (ROM) (434), and Hard Disk Drive (HDD) memory (436). Other types of memory may also be utilized and the specification contemplates the use of many varying types of memory in the data storage device (430) as may suit a particular application of the principles described herein. In certain examples, different types of memory in the data storage device (430) may be used for different data storage purposes. For example, in certain examples the processor (420) may boot from ROM (434, maintain nonvolatile storage in the Hard Disk Drive memory (436), and execute program code stored in RAM (432).

The data storage device (430) may include a computer readable medium, a computer readable storage medium, or a non-transitory computer readable medium among others. For example, the data storage device (430) may be an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory, a read-only memory, an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store, computer useable program code for use by or in connection with an instruction execution system, apparatus, or device. In another example, a computer readable storage medium may be any non-transitory medium that can contain, or store, a program for use by or in connection with an instruction execution system, apparatus, or device.

The data storage device (430) may contain a database (440). The database (440) may include files representing product offerings (110). For example, in response to an RFP, a consumer may receive multiple product offerings (110). The database (440) may include these product offerings (110) as well as files from which attributes (318) are extracted for these product offerings (110). In an example, the files are JSON files stored in the database (440). In another example, the database (440) may be maintained by a potential vendor, and may include product offerings (110) of the vendor to potentially fill an RFP.

Hardware adapters, including peripheral device adapters (422) in the system (400) enable the processor (240) to interface with various other hardware elements, external and internal to the system (400). For example, the peripheral device adapters (422) may provide an interface to input/output devices such as, for example, a display device (448). The peripheral device adapters (422) may also provide access to other external devices such as an external storage device, a number of network devices, such as, for example, servers, switches, and routers, client devices, other types of computing devices, and combinations thereof.

The display device (448) may be provided to allow a user of the system (400) to interact with and implement the functionality of the system (400). The peripheral device adapters (422) may also create an interface between the processor (400) and the display device (448), a printer, and/or other media output devices. The network adapter (424) may provide an interface to other computing devices within, for example, a network, thereby enabling the transmission of data between the system (400) and other devices located within the network.

The system (400) may, when executed by the processor (240), display a number of graphical user interfaces (GUIs) on the display device (448) associated with the executable program code representing the number of applications stored on the data storage device (430). The GUIs may display, for example, interactive screens that allow a user to interact with the system (400). Examples of display devices (448) include a computer screen, a laptop screen, a mobile device screen, a personal digital assistant screen, and a table screen among other display devices (448).

The system (400) includes a number of modules (442-446) used in the implementation of the system (400) and the methods described herein. The various modules (442-446) within the system (400) include executable program code that may be executed separately. In this example, the various modules (442-446) may be stored as separate computer program products. In another example, the various modules (442-446) with the system (400) may be combined within a number of computer program products; each computer program product including a number of modules (442-446). Examples of such modules include a conversion module (442), a clustering module (444) and a decision tree module (446).

The conversion module (442) converts files describing product offerings (110) into DAGs (100) describing product offerings (110). That is, the conversion module (442) parses the file and creates/populates nodes of the DAG (100) with the attributes (318) extracted from the file. In some examples, the conversion module (442) may weigh the attributes (318). In some examples, the conversion module (442) may standardize the order of the DAGs (100), for example, by ordering the attributes (318) based on decreasing weight. The conversion module (442) may operate just on a particular type of file, e.g., JSON files, or may be generalized to create/populate DAGs (100) from multiple file types. Working on a particular type of file may be implemented with fewer resources than a more generalized extraction module.

FIG. 4 also depicts the clustering module (444). The clustering module (444) groups the DAGs (100) into clusters based on similarity of the attributes (318) of the DAGs (100) as described above.

The decision tree module (446) receives a cluster (214) of DAGs (100) and forms a decision tree (300) to parse the received cluster (214). The decision tree may be formed using a decision tree (300) algorithm such as Iterative Dichotomiser 3 (ID3), the C4.5 algorithm, and/or C5.0 or See5. The decision tree module (446) may further include sub-components to parse the decision tree (300) and allow a user to receive a recommended product offering (110) based on the user's input. The user input may be provided in a document, such as a request for quote, and/or may be provided when parsing the decision tree (300).

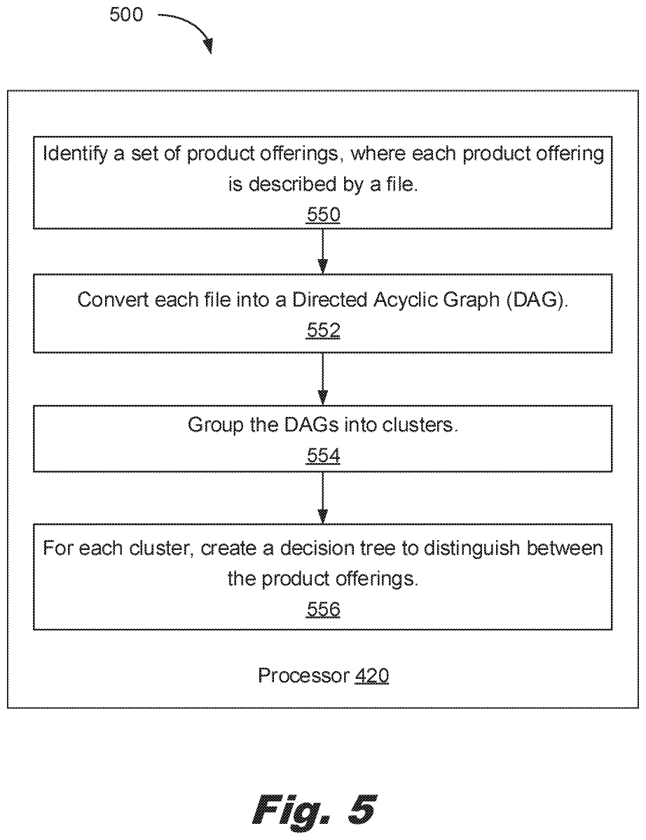

FIG. 5 shows a computer-implemented method (500) of identifying a product offering for a customer consistent with this specification

The method (500) includes identifying (550) a set of product offerings (110), where each product offering (110) is described by a file. For example, the product offerings may be products offered by different vendors to meet an RFP or may simply be different product offerings that were collected for analysis independent of an RFP to identify products that best meet a particular consumer's requirements for that product.

The method (500) includes converting (552) each file into a Directed Acyclic Graph (100). For example, as described above, the attributes (318) of the product offering (110) are mapped to nodes (112) of the DAG (100).

The method (500) includes grouping (554) the DAGs into clusters (214). As described above, each cluster (214) contains DAGs for a number of similar product offerings (110). Similarity may be assessed using the weighted separation of the DAGs (100) from each other. Specifically, pairs of DAGs (100) with smaller weighted separation have a higher similarity than pairs of DAGS (100) with larger weighted separation.

The method (500) includes, for each cluster (214), creating (556) a decision tree (300) to distinguish between the product offerings (110). Such a decision tree provides an efficient way for a user to navigate all possible product offerings to select one that meets certain client-determined criteria. Creating a decision tree (300) on the cluster (214) rather than the set of all product offerings (110) reduces the number of steps of the decision tree (300) a user needs to traverse.

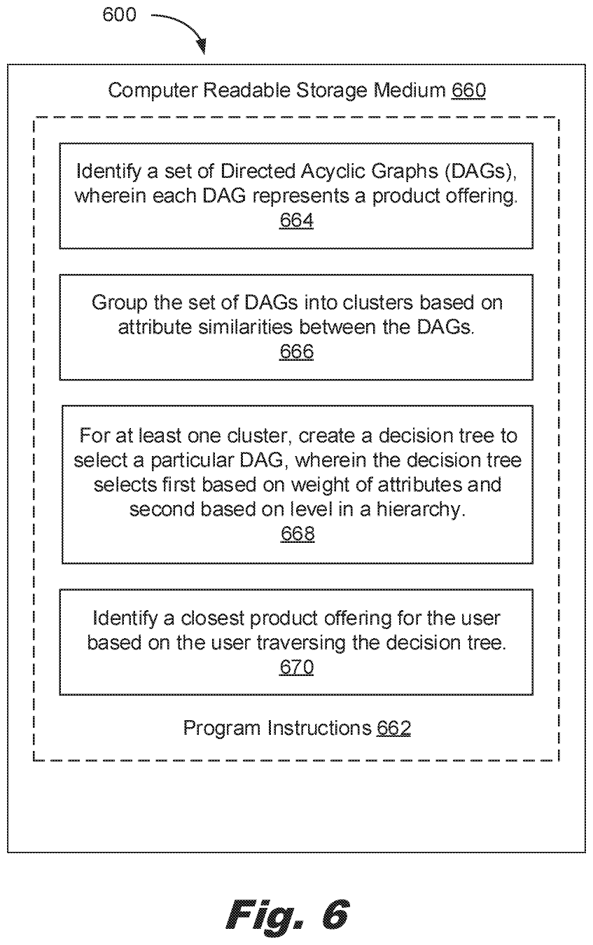

FIG. 6 shows a computer program product (600) for identifying a product offering (110) for a user, the computer program product (600) includes a computer readable storage medium (660) having program instructions (662) embodied therewith, the program instructions (662) executable by a processor (420).

The instructions cause the processor (420) to identify (664) a set of Directed Acyclic Graphs (100), wherein each DAG (100) represents a product offering (110). In one example, the set of DAGs (100) may be generated from a set of responses to a request for production. In other examples, the set of DAGs (100) may be generated in response to a request by the user. In any case, the set of DAGs (100) may be stored in a database.

The instructions cause the processor (420) to group (666) the set of DAGs into clusters (214) based on attribute (318) similarities between the DAGs. In an example, each cluster (214) contains DAGs (100) closer to a median point of the cluster (214) than to a median point of any other cluster (214). In some examples, the clusters (214) may be refined with an iterative process.

The instructions cause the processor (420) to for at least one cluster (214), create (668) a decision tree (300) to select a particular DAG (100), wherein the decision tree (300) selects an attribute (318) to make a decision at a level of a decision tree first based on a weight of attributes (318) and second based on a level in a hierarchy. As described above, in some examples the weights may be adjusted to prevent identical weightings for attributes (318).

The instructions cause the processor (420) to identify (670) a closest product offering (110) for a user based on the user traversing the decision tree (300). The closest product offering (110) may be provided in a quote for the product offering (110).

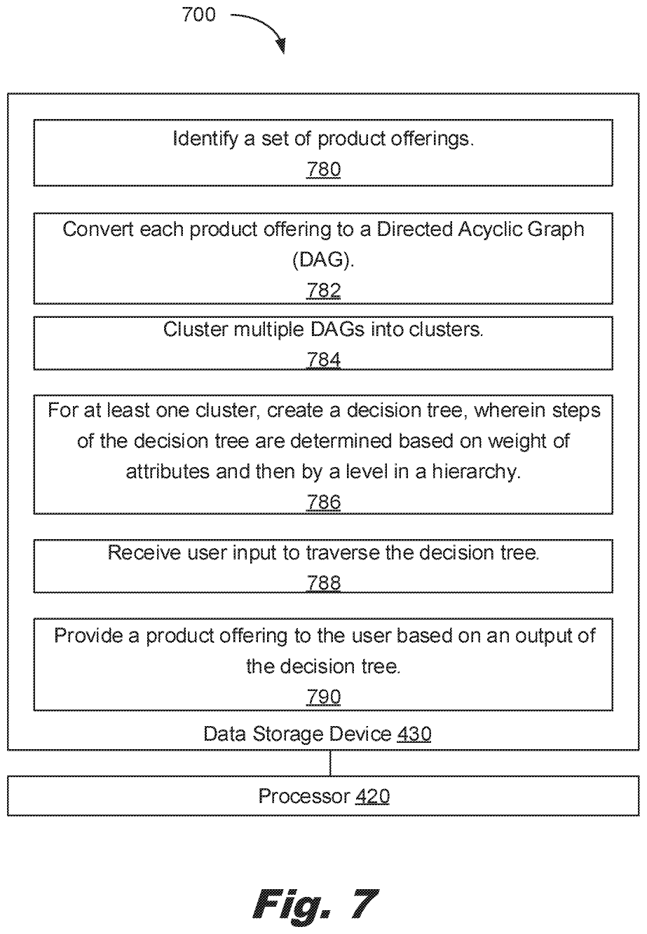

FIG. 7 shows a system (700) for identifying a product offering (110) for a user, the system (700) includes a processor (420) and a data storage device (430) functionally connected to the processor (700).

The system (700) causes the processor (420) to identify (780) a set of product offerings (110), which product offerings (110) may be presented as files in a database. The system (700) causes the processor (420) to convert (782) each product offering (110) into a Directed Acyclic Graph (100) such that the associated product offering (110) can be compared against other product offerings (110).

The system (700) causes the processor (420) to cluster (784) multiple DAGs (100) into clusters (214). Clustering reduces the size of the groups used to form the decision trees (300). This in turn reduces the number of levels of the decision trees (300).

The system (700) causes the processor (420), for at least one cluster (214), to create (786) a decision tree (300), wherein steps of the decision tree (300) are determined based on a weight of attributes (318) and then by a level in a hierarchy. The at least one cluster (214) may be selected based on the separation between the clusters (214) and an extracted product in a request for quote.

The system (700) causes the processor (420) to receive (788) user input to traverse the decision tree (300). The inputs may be provided in response to questions from the processor about preferences of the user.

The system (700) causes the processor (420) to provides (790) a product offering (110) to the user based on an output of the decision tree (300). The provided product offering (110) may be provided in a display. In an example, multiple product offerings (110) are provided in a ranked order of user preference.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising, by a processor:
identifying a set of product offerings, where each product offering is described by a file;
converting each file into a Directed Acyclic Graph (DAG);
grouping the DAGs into clusters; and
for each cluster, creating a decision tree to distinguish between the product offerings.

2. The computer-implemented method of claim 1, further comprising forming a composite product offering for a cluster, wherein the composite product offering comprises all attributes for each product offering represented in the cluster.

3. The computer-implemented method of claim 2, wherein any attribute in the composite product offering not possessed by a given DAG is assigned a null value.

4. The computer-implemented method of claim 2, wherein each attribute is assigned a weight.

5. The computer-implemented method of claim 4, wherein each weight is assigned by a user.

6. The computer-implemented method of claim 4, wherein each weight is assigned using a Term Frequency-Inverse Document Frequency (TF-IDF) operation.

7. The computer-implemented method of claim 1, wherein the DAGs are clustered based on having a difference under a threshold amount.

8. The computer-implemented method of claim 7, further comprising calculating a separation between two DAGs as a sum of all attribute differences between the two DAGs.

9. The computer-implemented method of claim 1, further comprising receiving a new product offering and, in response, updating each cluster and each decision tree.

10. A computer program product for identifying a product offering for a user, the computer program product comprising a computer readable storage medium having program instructions embodied therewith, the program instructions executable by a processor to cause the processor to:
identify a set of Directed Acyclic Graphs (DAGs), wherein each DAG represents a product offering;
group the set of DAGs into clusters based on attribute similarities between the DAGs;
for at least one cluster, create a decision tree to select a particular DAG, wherein the decision tree selects first based on a weight of attributes and second based on a level in a hierarchy; and
identify a closest product offering for a user based on the user traversing the decision tree.

11. The computer program product of claim 10, wherein grouping the set of DAGs into clusters based on attribute similarities between the DAGS comprises calculating attribute similarities based on weights.

12. The computer program product of claim 10, wherein at least one split in the decision tree is based on the weight of attributes and at least one split in the decision tree is based on the level in the hierarchy.

13. A system for identifying a product offering for a user, the system comprising:
a processor; and
a data storage device functionally connected to the processor, wherein the processor:
identifies a set of product offerings;
converts each product offering into a Directed Acyclic Graph (DAG);
clusters multiple DAGs into clusters;
for at least one cluster, creates a decision tree, wherein steps of the decision tree are determined based on a weight of attributes and then by a level in a hierarchy;
receives user input to traverse the decision tree; and
provides a product offering to the user based on an output of the decision tree.

14. The system of claim 13, wherein the product offerings of the set of product offerings are Global Trade Services (GTS) Solution Modules (GSMs).

15. The system of claim 13, wherein the decision tree for the at least one cluster has fewer levels than a decision tree for all the set of product offerings.

16. The system of claim 13, wherein the decision tree comprises at least one tiebreaker based on the weight and at least one tiebreaker based on the level in the hierarchy.

17. The system of claim 13, wherein the processor modifies the clustering to control a mean size of the clusters.

18. The system of claim 13, wherein clustering the multiple DAGs into clusters comprises:
identifying a weight for each attribute of any DAG;
assigning a null value to any attribute of a DAG without a value;
calculating distances between DAGs based on a sum over all attributes of differences of weights, wherein a cluster comprises a set of DAGs where all separations of DAGs within the set of DAGs are less than a threshold; and
dynamically adjusting the threshold to produce a distribution of clusters, wherein each cluster in the distribution of clusters contains no more than a fixed number of DAGs.

19. The system of claim 18, wherein the weight for each attribute is obtained from a file.

20. The system of claim 18, wherein the weight for each attribute is obtained using a Term Frequency-Inverse Document Frequency (TF-IDF) algorithm.
